(19) United States
(12) Patent Application Publication
(10) Pub. No.: US 2016/0056633 A1
(43) Pub. Date: Feb. 25, 2016

(54) SUPPLY DEVICE FOR SUPPLYING ELECTRICAL CURRENT TO AN ELECTRICAL GRID AND METHOD FOR OPERATING A SUPPLY DEVICE OF THIS TYPE

(71) Applicant: SIEMENS AKTIENGESELLSCHAFT, München (DE)

(72) Inventors: Norbert BENESCH, Heroldsberg (DE); Dominic BUCHSTALLER, Roettenbach (DE)

(73) Assignee: SIEMENS AKTIENGESELLSCHAFT, München (DE)

(21) Appl. No.: 14/779,844

(22) PCT Filed: Mar. 24, 2014
(86) PCT No.: PCT/EP2014/055814

§ 371 Date: Sep. 24, 2015

(30) Foreign Application Priority Data
Mar. 27, 2013 (DE) 10 2013 205 427.0

(51) Int. Cl. H02J 3/38

(52) U.S. Cl. CPC H02J 3/381; H02J 2003/388

(57) ABSTRACT

A supply device supplies electrical current provided by at least one current source to an electrical grid, the supply device having at least one current converter that can be electrically coupled to the current source and at least one connection device which is electrically coupled to an electrical line via an input connection and electrically coupled to the current converter via the line. The connection device is designed to be electrically coupled on the output side to the electrical grid and to adapt an electrical voltage at the input connection to an electrical voltage of the electrical grid at the output side.

### CROSS REFERENCE TO RELATED APPLICATIONS

This application is the U.S. national stage of International Application No. PCT/EP2014/055814, filed Mar. 24, 2014 and claims the benefit thereof. The International Application claims the benefit of German Application No. 102013205427.0 filed on Mar. 27, 2013, both applications are incorporated by reference herein in their entirety.

### BACKGROUND

Described below are a feed apparatus for feeding electric current into an electricity grid and a method for operating such a feed apparatus.

Such a feed apparatus for feeding electric current into an electricity grid and a method for operating such a feed apparatus have long been known from the related general art and are illustrated in FIG. 1.

FIG. 1 shows a basic illustration of a feed apparatus (denoted overall by 10) for feeding electric current into an electricity grid 12. The electric current to be fed into the electricity grid 12 is provided or generated by a current source 14. The current source 14 is a DC source, for example, wherein this may be a photovoltaic device. The current source 14 can also be in the form of an AC source, however.

The feed apparatus 10 includes a power converter 16, which can be coupled, and in the present case is coupled, to the current source 14. Since the current source 14 is a DC source in the present case, the power converter 16 is an inverter, by which the direct current provided by the current source 14 is converted into alternating current.

A stationary battery can also be used as DC source, for example. The power converter 16 is connected on the input side to the current source 14. On the output side, the power converter 16 is connected to a so-called line filter 18 of the feed apparatus 10. The line filter 18 is used, for example, for filtering and therefore blocking interference or interference signals which are generated by the power converter 16 itself. For this purpose, the line filter 18 has discrete components, for example.

The line filter 18 is electrically coupled to a connecting device 20 of the feed apparatus 10. As a result, the power converter 16 is electrically connected to the connecting device 20 via the line filter 18.

The connecting device 20 is designed to match an input-side voltage provided by the power converter 16, for example, to an output-side electric voltage of the electricity grid 12. For this purpose, the connecting device 20 includes, for example, at least one matching element 22. This matching element may be a voltage transformer, for example.

The connecting device 20 acts as node element or node at which the feed apparatus 10 and therefore the current source 14 can be electrically connected to the electricity grid 12.

The electrical connection of the connecting device 20 to the line filter 18 is performed by an electrical line 24 (illustrated very schematically in FIG. 1) in the form of a low-voltage electrical line, which has a certain resistance R and an inductance L. The connecting device 20 is electrically connected to the electrical line 24 via its input connection and via the electrical line to the power converter 16.

A power flow or a flow of three-phase alternating current, for example, or of direct current from the current source 14 into the grid 12 is illustrated by directional arrows in FIG. 1.

In order to fulfill the feeding of electric current or electrical energy into the electricity grid 12, the power converter 16 requires important information.

One such piece of information is the impedance, in particular the so-called line impedance of the very long electrical line 24. Knowledge of the impedance is important for control or regulation of the power converter 16 since the impedance plays an important role in the dynamic behavior of the entire system. Further important information is the electric voltage in particular at the connecting device 20 since the power converter 16 needs to match the input-side voltage, based on the power converter 16, to the input-side voltage of the connecting device 20 in order to avoid uncontrolled current flow. In addition, the phase of the current and/or the voltage, in particular at the connecting device 20, is important, wherein the power converter 16 needs to match the phase of the input-side current to the phase at the connecting device 20 in order to avoid short circuits.

Furthermore, detection of a so-called island operating mode can also be provided. If the so-called island operating mode of the power converter 16 occurs, it is advantageous to disconnect the power converter 16 immediately in order to ensure a high degree of safety and to avoid undesired damage. Further important information can be the so-called demand response. In this case, demand response is a short term and possibly plannable change to the consumer load in response to price signals on the market or activation as part of a contractual power reserve. These market prices or power requests are triggered by unplanned, irregular or extreme energy management events.

Primarily in the case of high-power devices, a power supply company operating the electricity grid 12, i.e. the electricity operator, has the possibility of controlling the feed of electric current into the electricity grid 12. The electricity operator is capable, for example, of deactivating the power converter 16 when the electricity grid 12 is unstable owing to an excess of generated energy. In addition, important information may be the price of electric current, i.e. the electricity price. It is expected that, in particular in future electricity networks, the current price for electric current which is fed into electricity grids will be dynamic. The electricity price will vary depending on supply and demand and possibly even will be negative if there is an oversupply of electric current.

Generally, the impedance, in particular at least an impedance value characterizing the impedance, is determined offline. This means that the impedance value is calculated when no current is being fed into the electricity grid 12. The determination of the impedance or the impedance value is generally performed in such a way that a specific nominal value for the impedance is assumed. As an alternative or in addition, provision can be made for the impedance value to be provided or estimated roughly on the user side, wherein this estimation is generally performed using frequency response measurements which are implemented by the power converter 16.

Since the electric voltage, the electric current and the phase at the connecting device 20 are generally not detected, they need to be counted back from the electric voltage and the electric current at the power converter 16. This can only take place when the impedance and the topology of the line filter 18 including its components are known. Therefore, the impedance is not only important for the control or regulation of the power converter 16 itself, but the impedance also plays an important role in the determination of the electric voltage, the electric current and the phase at the connecting device 20. If the impedance is not determined correctly, the electric voltage and the phase of the electricity grid 12 will also be calculated incorrectly.

The outlined offline calculation of the impedance of the electrical line 24, wherein the voltage, the current and the phase at the connecting device 20 are counted back from the measurements at the power converter 16, functions well when the impedance is at least substantially constant and low, as is the case, for example, in the case of a strong and stable electricity grid 12. However, in electricity grids in which the impedance is increasingly uncalculable, such an offline calculation of impedances is insufficient. Examples of electricity grids having changing and/or high impedances are those on merchant vessels, in future intelligent electricity grids, i.e. in electricity grids with a large number of distributed, fluctuating and local energy sources such as, for example, wind systems or photovoltaic systems and in situations with regenerative energy sources at the end of long distribution lines.

### SUMMARY

As described in more detail below, a feed apparatus and a method of the type mentioned at the outset can determine the impedance, the electric voltage and the phase reliably at the connecting device, in particular even when there are dynamic changes in the entire system including the current source, the feed apparatus and the electricity grid.

A first aspect relates to a feed apparatus for feeding electric current provided by at least one current source into an electricity grid. The feed apparatus has at least one power converter, which can be electrically coupled to the current source. The feed apparatus furthermore includes at least one connecting device.

The connecting device is electrically coupled via its input connection to an electrical line and via this electrical line to the power converter. On the output side, the connecting device can be electrically coupled to the electricity grid. The connecting device is designed to match an electric voltage present at the input connection to an output-side electric voltage of the electricity grid. For this purpose, the connecting device includes at least one transformer, for example.

The feed apparatus includes a detection device, which is coupled to the connecting device and by which at least one voltage value characterizing the electric voltage present at the input connection can be detected. In addition, a current value characterizing an electric current received via the electrical line at the input connection can be detected by the detection device. In other words, the detection device is designed to detect the voltage value and the current value, wherein the voltage value characterizes the electric voltage which is present across the electrical line at the input connection of the connecting device and therefore at the connecting device. The current value characterizes the electric current which is transmitted from the power converter via the electrical line to the connecting device to the input connection thereof.

The feed apparatus also includes an evaluation device, which is coupled to the power converter and to the detection element. At least one impedance value characterizing an impedance of the electrical line is to be calculated by the evaluation device. Furthermore, at least one phase value characterizing a phase of the voltage and/or the current of the input connection is to be calculated by the evaluation device. The calculation of the impedance value and the current value in this case takes place depending on the detected voltage value transmitted to the evaluation device and depending on the detected current value transmitted to the evaluation device.

In the feed apparatus, the electric voltage and the electric current are detected at the input connection of the connecting device and therefore at the connecting device itself and used to calculate the impedance of the electrical line and the phase at the connecting device. The calculation of the phase is performed, for example, by a phase-locked loop (PLL). The impedance and the phase in the feed apparatus can therefore be determined particularly precisely and do not need to be determined or estimated on the basis of back-calculations and/or estimations and/or fixed, preset values. Therefore, the impedance and the phase can also be determined reliably and precisely when there are dynamic changes in the overall system, including the current source, the feed apparatus and the electricity grid. As a result, a particularly requirements-based and safe feed of electric current provided by the current source into the electricity grid can be realized.

In a further configuration, the detection device is designed to detect an island operating mode of the connecting device and to transmit at least one island value characterizing the island operating mode to the evaluation device. An island operating mode refers to such a state of the connecting device and therefore of the feed apparatus or the current source in which electric current is still fed from the current source into the electricity grid although the electricity grid itself or another feed of current into the electricity grid is no longer provided. If the detection of such an island operating mode is provided, corresponding measures such as, for example, reliable and quick shutdown of the power converter and/or quick decoupling of the feed apparatus from the electricity grid can be effected depending on the detected island operating mode. This results in particularly safe operation of the feed apparatus and the electricity grid overall. Furthermore, any resultant damage from the island operating mode can be avoided.

It has furthermore proven to be particularly advantageous if the detection device is designed to detect at least one island value, characterizing the island operating mode, from a power supply company operating the electricity grid, i.e. from an operator of the electricity grid. As a result, it is also possible for the operator to actively preset whether and when there is an island operating mode. In particular, at least one criterion can thus be preset, and when this criterion is met the island operating mode is present. Thus, particularly safe and requirements-based operation of the feed apparatus can be realized.

In a further particularly advantageous configuration, the detection device is designed to detect at least one price value characterizing the price of electric current and/or at least one demand response value, characterizing a demand response, from the power supply company and to transmit this to the evaluation device. The power converter can thus also be operated depending on the demand response value and/or depending on the price value and therefore in a particularly requirements-specific manner. In this case, demand response is a short-term, plannable change to the consumer load in response to price signals on the market or in response to activation as part of a contractual power reserve. These market prices or power requests are triggered by unplanned, irregular or extreme energy management events.

A further embodiment is wherein the fact that the evaluation device is designed to receive, from the power converter, at least one further current value characterizing a further electric voltage which can be provided by the current source and/or the power converter and/or at least one flow value characterizing an electrical current flow which can be provided by the current source and/or the power converter and/or at least one power value characterizing an electric power which can be provided by the current source and/or the power converter. As a result, it is possible to operate the power converter by the evaluation device depending on a multiplicity of different types of information and therefore to match control or regulation of the power converter which is implemented by the evaluation device particularly well to present boundary conditions which in particular change over time. As a result, particularly safe and requirement-specific and efficient operation can be realized.

In a further advantageous embodiment, at least one filter for filtering interference is assigned to the power converter, wherein the evaluation device is configured to detect at least one filter value characterizing the filter. The filter serves the purpose of filtering interference or interference signals on the electrical line. As a result of the detection of the filter value, the topology, i.e. the behavior and/or the design of the filter, can also be incorporated in the control or regulation of the power converter, for example. As a result, the power converter can be operated in a manner which is particularly specific to requirements and efficient.

It has furthermore proven to be particularly advantageous if the evaluation device is configured to calculate at least one power value characterizing an electric power to be provided by the current source via the power converter depending on values transmitted to the evaluation device and/or depending on values detected by the evaluation device and to transmit this at least one power value to the power converter. At least some of the abovementioned values can be incorporated in the calculation of the power value. All of the mentioned values may be taken into consideration in the calculation of the power value, with the result that the power value can be matched particularly well to the prevailing boundary conditions. As a result, operation of the power converter and in particular of the current source can also be matched to the conditions changing in particular over time in a manner which is suitable for the requirements, efficient and effective. In particular, it is possible to take into consideration changes in the impedance and to match the operation of the feed apparatus to these changes in impedance.

A second aspect relates to a method for operating a feed apparatus for feeding electric current provided by at least one current source into an electricity grid. The feed apparatus has at least one power converter, which can be electrically coupled to the current source, and at least one connecting device, which is electrically coupled via its input connection to an electrical line and via the electrical line to the power converter. On the output side, the connecting device can be electrically coupled to the electricity grid. Furthermore, the connecting device is designed to match an electric voltage present at the input connection to an output-side electric voltage of the electricity grid. In other words, the method can be used for operating the feed apparatus.

Accordingly, provision is made for at least one voltage value characterizing the voltage present at the input connection and at least one current value characterizing an electric current received via the electrical line at the input connection to be detected by a detection device, coupled to the connecting device, of the feed apparatus. In addition, at least one impedance value characterizing an impedance of the electrical line and at least one phase value characterizing a phase of the voltage and/or of the current at the input connection are calculated by an evaluation device, which is coupled to the power converter and to the detection device, of the feed apparatus depending on the voltage value and current value detected and transmitted to the evaluation device. Advantageous configurations of the feed apparatus should be regarded as advantageous configurations of the method, and vice versa.

Within the scope of the method, the impedance and the phase are calculated on the basis of the detected voltage and the detected current at the input connection of the connecting device. As a result, changes in the impedance can also be detected reliably. Furthermore, calculation of the voltage, the phase and the current at the connecting device by back-calculation from the current and the voltage at the power converter is not necessary and not envisaged since the voltage and the current can be detected at the connecting device and therefore the phase can be calculated directly and precisely. Only in the event of a fault, for example in the event of failure of communication, is a known back-calculation used.

### BRIEF DESCRIPTION OF THE DRAWINGS

These and other aspects and advantages will become more apparent and more readily appreciated from the following description of the exemplary embodiments, taken in conjunction with the accompanying drawings of which:

These and other aspects and advantages, features and details are set forth in the description below relating to exemplary embodiments and with reference to the accompanying drawings of which:

FIG. 1 is diagram using three-dimensional representations of components in a basic illustration of a feed apparatus for feeding electric current provided by a current source into an electricity grid in accordance with the related art;

FIG. 2 is a composite block diagram with three-dimensional representations of some components in a basic illustration of a feed apparatus in accordance with a first embodiment for feeding electric current provided by a current source into an electricity grid, wherein the feed apparatus includes a detection device and an evaluation device, by which a phase and an impedance of the feed apparatus can be determined precisely;

FIG. 3 is a block diagram of the feed apparatus in accordance with the first embodiment; and

FIG. 4 is a composite block diagram with three-dimensional representations of some components in a further basic illustration of the feed apparatus in accordance with a second embodiment.

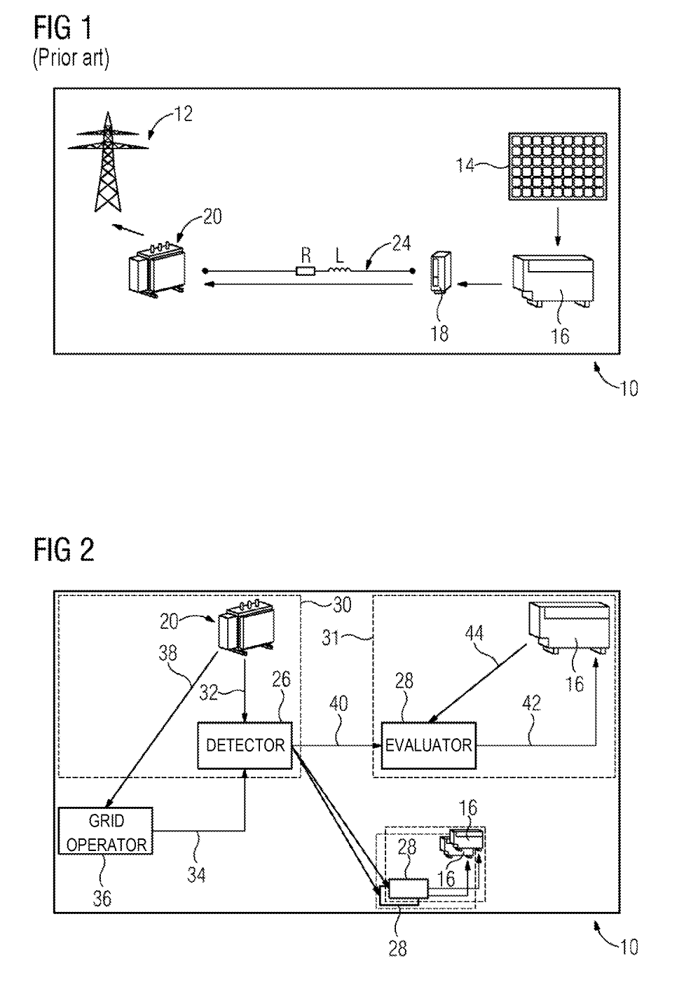

### DETAILED DESCRIPTION OF THE PREFERRED EMBODIMENT

Reference will now be made in detail to the preferred embodiments, examples of which are illustrated in the accompanying drawings, wherein identical or functionally identical elements are provided with the same reference symbols in the figures.

FIG. 2 shows the feed apparatus 10, wherein the power flows and components are not illustrated, but only the communication devices are illustrated in FIG. 2.

The feed apparatus 10 shown in FIG. 2 includes a detection device 26 and an evaluation device 28. As is illustrated in FIG. 2 by a dashed line 30, the detection device 26 is assigned to the connecting device 20 having the transformer. The connecting device 20 having the transformer and the detection device 26 are located in the vicinity of the power supply company, typically on the same company grounds. For example, they are less than 100 meters apart from one another. The detection device 26 is also referred to as a measuring and data collection device since it is used for detecting and collating data.

As is indicated by a directional arrow 32 in FIG. 2, the detection device 26 is coupled to the connecting device 20. This connection between the connecting device 20 and the detection device 26 is formed by a communications and input interface, for example. Detection of all network-relevant information is performed by the detection device 26. This network-relevant information is in particular the electric voltage which is present across the electrical line 24 at the corresponding input connection of the connecting device 20. In addition, this network-relevant information is an electric current received via the electrical line 24 at the input connection. In other words, at least one voltage value characterizing the voltage present at the input connection and at least one current value characterizing an electric current received via the electrical line 24 at the input connection are transmitted by the connecting device 20 to the detection device 26 and detected by the detection device 26.

Furthermore, at least one island value characterizing an island operating mode of the connecting device 20 is transmitted from the connecting device 20 to the detection device 26 and is detected there by the detection device 26. On the basis of the island value, the detection device 26 is used to detect whether switches and/or contacts are open or closed and whether the feed apparatus 10 is therefore electrically coupled to the electricity grid 12 or decoupled from the electricity grid 12 via the connecting device 20 or whether current is still intended to be fed from the current source 14 into the electricity grid 12.

As is indicated by a directional arrow 34, the detection device 26 is also coupled to a power supply company 36 operating the electricity grid 12, i.e. a grid operator. The detection device 26 detects from the power supply company 36 at least one demand response value characterizing a demand response and at least one island value characterizing the island operating mode. Furthermore, at least one price value characterizing the price of electric current is transmitted from the power supply company 36 to the detection device 26 and is accordingly detected by the detection device 26. As is illustrated by a directional arrow 38, a corresponding flow of information from the connecting device 20 to the power supply company 36 can also be provided.

A connection between the detection device 26 and the evaluation device 28 is illustrated by a directional arrow 40, wherein this is in particular a data link. This connection between the detection device 26 and the evaluation device 28 is provided, for example, by a communications interface with a corresponding communications link. This may be an electrical line communication, an Ethernet, a DSL (digital subscriber line) or the like.

The detection device 26 has a computation core, which is designed to implement real-time conditioning of data. Furthermore, the computation core is designed to transmit the outlined values and at least some of these outlined values of the network information system to the evaluation device 28. The data transmitted from the detection device 26 to the evaluation device 28 are may be provided with a time stamp in order to be able to compensate for variable transmission delays.

As is illustrated by a dashed line 31, the evaluation device 28 is in particular assigned to the power converter 16. The evaluation device 28 is used for the evaluation and synthesis of the data transmitted by the detection device 26. The evaluation device 28 in particular has the task of transmitting all relevant information for regulating the power converter 16 to the power converter, which is indicated by a directional arrow 42.

The evaluation device 28 includes, for this purpose, a corresponding communications interface, via which the evaluation device 28 is connected to the detection device 26. Furthermore, a corresponding communications interface is provided via which the evaluation device 28 is connected to the power converter 16. This may be a CAN (controller area network) bus or a Profibus.

As illustrated by a directional arrow 44, at least one further voltage value characterizing an electric voltage which can be provided by the current source 14 and/or by the power converter 16 and/or at least one flow value characterizing an electric current flow which can be provided by the current source 14 and/or by the power converter 16 and/or at least one power value characterizing an electric power which can be provided by the current source 14 and/or by the power converter 16 and is therefore available and at least one filter value characterizing the line filter 18, in particular the topology thereof is/are transmitted from the power converter 16 to the evaluation device 28, wherein the evaluation device 28 detects these values. From the evaluation device 28, the first voltage value, i.e. the voltage at the input connection of the connecting device 20, and the current value, i.e. the current at the input connection of the connecting device 20, are transmitted to the power converter 16. Furthermore, the island value or the island values, the demand response value and the price value are transmitted from the evaluation device 28 to the power converter 16.

By the evaluation device 28, at least one impedance value characterizing an impedance of the electrical line 24 and at least one phase value characterizing a phase of the voltage and/or the current at the input connection of the connecting device 20 are also determined depending on the detected first voltage value and current value transmitted to the evaluation device 28, wherein the phase value and the impedance value are transmitted from the evaluation device 28 to the power converter 16. The evaluation device 28, calculates at least one power setpoint value characterizing an electric power to be provided by the current source 14 via the power converter 16 depending on the values transmitted to the evaluation device 28 and/or depending on the values detected by the evaluation device 28 and transmits the setpoint value to the power converter 16.

The evaluation device 28 has a computation core with a real-time clock or a real-time clock source, by which real-time data processing can be implemented. As a result, the data from the data stream emerging from the detection device 26 can be received and obtained correctly in time. In addition, it is possible to interpolate data values from delayed or lost data packets. On the basis of the collated information, the network impedance can be calculated. Furthermore, the phase at the connecting device 20 can be calculated from the voltage and the current, for example by a phase-locked loop.

On the basis of the demand response value, the island value and/or the price value and on the basis of the power value, the required power, i.e. the setpoint power value, can now be calculated using rules, heuristics and/or optimization algorithms.

As illustrated in FIG. 2, a plurality of evaluation devices 28 can be coupled to the detection device 26, which is assigned to the connecting device 20, and the evaluation devices are in turn each connected to a power converter 16. It is thus possible to feed electric current which is provided by a multiplicity of individual, local current sources into the electricity grid 12 efficiently and in a requirements-based fashion via the connecting device 20.

Respective hardware platforms for implementing the detection device 26 and the evaluation device 28 can be based on embedded systems having only a very low power consumption, such as ARM or MIPS processors, for example. The respective communications interfaces and data detection systems are either implemented on-board, i.e. integrated in the connecting device 20 or in the power converter 16, or are embodied as respective components which are different from the connecting device 20 or the power converter 16, are separate and are provided in addition thereto, the components being connected in a corresponding manner to the connecting device 20 or to the power converter 16.

Transmission delays between the connecting device 20, the detection device 26, the evaluation device 28 and the power converter 16 are desired to be low, such as less than 100 ms to be able to respond to suddenly occurring events such as a drop in impedance within a period of 50 Hz. A required bandwidth is relatively small. For example, the transmission of one hundred 32-bit values every 20 ms results in a transmission rate of 160 kilobits/second. As a result, the complexity involved with communications elements such as connecting elements and connecting interfaces, their weight and their costs can be kept low.

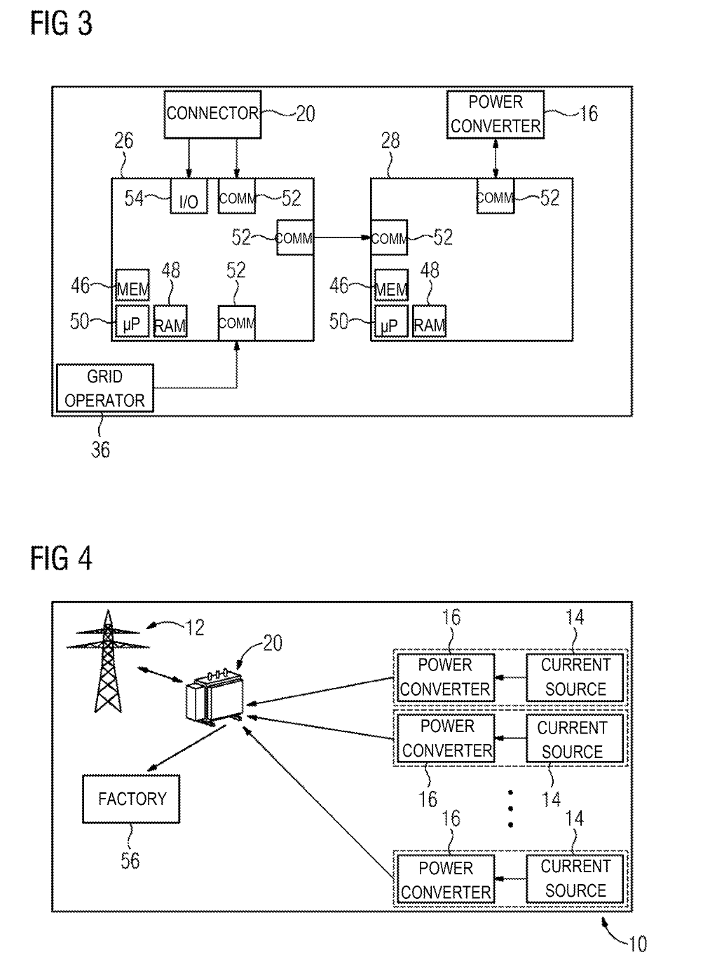

The design of the detection device 26 and the evaluation device 28 can be seen particularly well in FIG. 3. As can be seen from FIG. 3, the detection device 26 and the evaluation device 28 each includes a flash memory 46, a RAM 48 and the computation core denoted by 50. A respective communications interface is denoted by 52. In addition, an analog or digital input and output interface is denoted by 54.

FIG. 4 illustrates that a multiplicity of current sources 14, for example in the form of photovoltaic systems, can be coupled to the electricity grid 12 via a respectively assigned power converter 16 and the connecting device 20 in the manner illustrated. FIG. 4 uses directional arrows to illustrate a respective flow of electric current, wherein this may be a three-phase alternating current or direct current. The respective, advantageous functions of the feed apparatus 10 are illustrated particularly well in FIG. 4.

The current sources 14 are part of an intelligent electricity grid, by which a central production of electric current up to distributed and local energy generation can be realized. In the specific example in accordance with FIG. 4, a multiplicity of photovoltaic systems is provided which are installed, for example, on roofs of buildings, in particular commercial buildings, and can feed electric current via the common connecting device 20 into the common electricity grid 12. A factory 56 which is in the region of the current sources 14 of the main energy consumer is located in the surrounding environment of the local current sources 14. Other energy consumers such as, for example, private households only consume a very low quantity of energy in comparison with the factory and can be disregarded in the text which follows.

In order to take account of the possibility that the local energy generation effected by the photovoltaic systems drops, the factory can restrict its production and therefore reduce its energy consumption. Such a drop in energy production arises, for example, when the sky is clouded over and therefore the sun is covered by cloud. In order to be able to match the production and therefore the energy consumption of the factory to the energy generation or energy production which can be provided by the photovoltaic systems, a corresponding production management system of the factory is provided, for example.

On a sunny, cloud-free day, the production performance and therefore the energy consumption of the factory is 100%, for example. The connecting device 20 is in this case operated at 80% of its maximum capacity, for example. 100% of the energy generated locally by the photovoltaic systems is consumed, while 20% of the energy required by the factory 56 is drawn from the electricity grid 12 and 80% from the photovoltaic systems (current sources 14).

If there is now suddenly cloud cover, the energy generated by the photovoltaic systems can drop within only two seconds to 10% of its original value which can be or is realized during sunny conditions. Since this energy deficit cannot be compensated for by energy from the electricity grid 12, the production performance and therefore the energy consumption of the factory 56 are restricted by the production management system and matched to the available energy. This operation lasts 30 seconds, for example. In the meantime, the connecting device 20 and the local current sources 14 and power converters 16 are overloaded, which results in the virtual impedance visible to the power converters on the electrical line 24 increasing. Since the detection device 26 constantly monitors the current and the voltage at the connecting device 20 and transmits the current and voltage to the individual evaluation devices 28 of the current sources 14, the respective evaluation device 28 can determine the impedance and transmit the impedance value to the respective power converter 16. The respective power converters 16 can match, by corresponding regulation, the feed of electric current correspondingly. For this purpose, for example, a regulator optimized for the determined impedance is used in order to ensure the stability of the network and a correct phase and a correct voltage of the current sources 14 and of the power converters 16, respectively.

In contrast to this, if the detection device 26 and the evaluation devices 28 were not provided, the respective power converters 16 would continue to feed electric current or to transmit electric current to the connecting device 20 assuming that the electricity grid 12 has a low inductance and impedance, respectively. This could result in only a very poor energy quality and/or in network instabilities.

A further situation differing from this could arise when the factory 56, for example owing to an operating error, adjusts its production and therefore its energy consumption to a maximum despite the energy required for this not being available. At a specific point in time, an emergency system of the connecting device 20 will detect a severe resultant overload of the transformer and decouple the local network, i.e. the current sources 14, from the electricity grid 12. The factory 56 and the photovoltaic systems generating energy locally are now in an island operating mode. Since, however, the detection device 26 detects the state of switches and conductors at the connecting device 20, it also detects the island operating mode and immediately transmits the island value characterizing the island operating mode to the individual evaluation devices 28 of the current sources 14. The individual evaluation devices 28 can then activate a respective emergency shutdown of the individual power converters 16 so that, as a result, the network operating in the island operating mode can be switched to an energyless state within a very short time.

The use of the detection device 26 and the evaluation device 28 therefore enables a reliable, time-oriented and complete supply of information to the power converter 16. As a result, the control or regulation of the respective power converter 16 can be simplified. Furthermore, improved operation of the power converter 16 even under difficult conditions such as, for example, on ships or in intelligent electricity grids can thus be realized.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-8. (canceled)

9. A feed apparatus for feeding electric current provided by at least one current source into an electricity grid, comprising:
at least one power converter electrically connectable to the at least one current source;
an electrical line electrically coupled to the at least one power converter;
at least one connecting device, having an input connection electrically coupled to the power converter via the electrical line and an output electrically connectable to the electricity grid, configured to match an input voltage at the input connection to a grid voltage of the electricity grid;
a detection device, coupled to the connecting device, detecting at least one voltage value characterizing the input voltage and detecting at least one current value characterizing an input current received via the electrical line at the input connection of the at least one connecting device; and
an evaluation device, coupled to the at least one power converter and the detection device, calculating at least one impedance value characterizing an impedance of the electrical line and calculating at least one phase value characterizing a phase of at least one of the input voltage and the input current at the input connection based on the input voltage value and the at least one current value transmitted to the evaluation device.

10. The feed apparatus as claimed in claim 9, wherein the detection device detects an island operating mode of the at least one connecting device and transmits at least one island value characterizing the island operating mode to the evaluation device.

11. The feed apparatus as claimed in claim 10, wherein a power supply company operates the electricity grid, and
wherein the detection device detects the at least one island value, characterizing the island operating mode, from the power supply company operating the electricity grid.

12. The feed apparatus as claimed in claim 9, wherein a power supply company operates the electricity grid, and
wherein the detection device detects at least one price value characterizing a price of at least one of electric current and at least one demand response value, characterizing a demand response, from the power supply company operating the electricity grid and to transmit the demand response value to the evaluation device.

13. The feed apparatus as claimed in claim 9, wherein the evaluation device receives, from the power converter, at least one of
at least one further current value characterizing an electric voltage which can be provided by at least one of the current source and the power converter,
at least one flow value characterizing an electrical current flow which can be provided by at least one of the current source and the power converter, and
at least one power value characterizing an electric power which can be provided by at least one of the current source and the power converter.

14. The feed apparatus as claimed in claim 9,
further comprising at least one filter filtering interference assigned to the power converter, and
wherein the evaluation device is configured to detect at least one filter value characterizing the filter.

15. The feed apparatus as claimed in claim 9, wherein the evaluation device is configured to calculate at least one power value characterizing an electric power to be provided by the current source via the power converter based on values at least one of transmitted to and detected by the evaluation device and to transmit the at least one power value to the power converter.

16. A method for operating a feed apparatus for feeding electric current provided by at least one current source into an electricity grid, the feed apparatus including at least one power converter, electrically connectable to the at least one current source, and at least one connecting device, having an input connection electrically coupled to the power converter via an electrical line and an output electrically connectable to the electricity grid, configured to match an input voltage at the input connection to a grid voltage of the electricity grid, said method comprising:
detecting, by a detection device, coupled to the connecting device, of the feed apparatus, at least one voltage value characterizing the input voltage and at least one current value characterizing an input current received via the electrical line at the input connection; and
calculating, by an evaluation device, coupled to the power converter and the detection device, of the feed apparatus, at least one impedance value characterizing an impedance of the electrical line and at least one phase value characterizing a phase of at least one of the input voltage and the input current at the input connection based on the input voltage value and the at least one current value transmitted to the evaluation device.
